(19) United States
(12) Patent Application Publication
(10) Pub. No.: US 2012/0294163 A1
(43) Pub. Date: Nov. 22, 2012

(54) Apparatus and Method for Direct Device-to-Device Communication in a Mobile Communication System

(75) Inventors: Samuli TURTINEN, Ii (FI); Timo Koskela, Oulu (FI); Sami-Jukku Hakola, Kempele (FI)

(73) Assignee: Renesas Mobile Corporation

(21) Appl. No.: 13/111,032

(22) Filed: May 19, 2011

(51) Int. Cl. H04W 56/00; H04W 28/26; H04W 24/00

(52) U.S. Cl. 370/252; 370/280

(57) ABSTRACT

The invention concerns a method and an apparatus implementing the method. In the method at least one synchronization signal is received from a base station to a mobile node, which determining timing based on the at least one synchronization signal, for example, a group of orthogonal frequency division multiple access resource elements. The mobile node transmits an uplink radio resource reservation request to a base station. The mobile node receives from the base station an assignment of a radio resource dedicated for radio transmission to a remote node, the radio resource being within a band having a transmission power upper limit. The mobile node transmits a signal to the remote mobile node on the radio resource based on the timing determined.

### BACKGROUND OF THE INVENTION

1. Field of the Invention

The invention relates to mobile communications networks, device-to-device communication between end user devices, and an apparatus and a method for direct device-to-device communication in a mobile communication system.

2. Description of the Related Art

The field of data communications has been in turmoil during the recent years. New technologies are being introduced while old technologies are being dismantled. Particularly, the data rates in wireless mobile communication systems have been increasing in the recent years rapidly. Long-Term Evolution (LTE) standardized by the 3G Partnership Project (3GPP) represents a significant leap forward in wireless mobile communication systems. One of the main objectives of the LTE is the providing of downlink data rates of at least 100 Mbps and uplink date rates of at least 50 Mbps. The LTE operates in two modes, namely the Frequency Division Duplex (FDD) and the Time Division Duplex (TDD). In FDD the uplink and downlink transmissions use different frequency bands, which are separated by a frequency offset. Thus, the FDD operates in paired frequency bands. From a mobile node, that is, user equipment perspective there are two carrier frequencies one for the uplink transmission and another for the downlink reception. The downlink reception and uplink transmission occur simultaneously. The downlink reception uses the Orthogonal Frequency Division Multiple Access (OFDMA) while the uplink transmission uses the Single Carrier Frequency Division Multiple Access (SC-FDMA). The reason for the use of SC-FDMA in uplink transmission is the high Peak-to-Average Power Ratio (PAPR) in OFDMA signal transmission. An amplifier in an OFDMA transmitter must stay in amplifier linear area by using extra power back-off. This leads to increased battery consumption or shorter uplink range. The shorter uplink range may be a problem for mobile nodes that are far from a base station. In FDD the problem is the required availability of enough radio spectrum for the paired band. Therefore, TDD has been standardized as an alternative for FDD. TDD uses the same frequency band for transmission and reception so that the base station and the mobile node take turns in transmission. TDD emulates full-duplex transmission in a transmission which is essentially half-duplex in nature. This is possible because of the rapid change in the transmission direction. The effect is not felt in present day conversational and streaming services. TDD offers seven configurations for uplink and downlink transmission alternation. The configurations comprise downlink intensive, uplink intensive or balanced transmission schemes. The number of subframes allocated for uplink and downlink vary in the configurations. A direction change occurs at least during a single subframe within a 10 ms radio frame. For the direction change there is a guard period. TDD offers a lucrative option whenever new frequency bands are made available for LTE. Some of the frequency bands may be wide enough for practical FDD transmission and TDD may be used instead within these frequency bands. One example of such frequency bands are the so called Television White Spaces (TVWS).

Frequency bands previously allocated to television channels are being opened for other uses. This is at least partly due to the dismantling of analog television broadcasting systems in many countries. Unused television channels or channel sets may be referred to as TVWS. For example, in USA the Federal Communications Commission (FCC) has decided to open spectrum traditionally allocated for television broadcast to provide wireless broadband access. One possible use for the spectrum opened is LTE transmission. TDD may be used on the spectrum due to coordination issues or due to possible discontinuity or narrowness in the television channels available. It is possible that there are only a few adjacent white space TV channels among the set of TVWS channels. The maximum allocation of a 20 MHz band for LTE is problematic at least for in downlink direction. Therefore, there is not necessarily enough continuous band for the FDD which requires paired bands. The TDD may be more suitable for transmission in the TVWS. A further property of the TVWS is that on the TV channels immediately adjacent in the frequency domain to an active TV channel there are limits for transmission power in order to avoid band energy leakage to the active TV channel and resulting interference. Therefore, there are problems if downlink transmission from a base station to a mobile node must be performed in the frequency band of a TV channel that is immediately adjacent to a TV channel in active use. The high power in the downlink transmission is likely to cause interference in TV set receivers located within the coverage area of the base station. The downlink transmission power from the base station must be limited, which reduces the cell size. Similar considerations are present in the cases where bands near in the frequency domain to a band used for other purposes are available, for LTE use and could thus be used for base station downlink transmission.

Several types and modes of TVBDs have been defined by the FCC based on their characteristics. A fixed TVBD transmits and receives radio communication signals at a specified fixed location. There are mode I and mode II portable, that is, personal devices. A sensing only device is a portable TVBD that uses spectrum sensing to determine a list of available channels. It may use the frequency bands 512-608 MHz (TV channels 21-36) and 614-698 MHz (TV channels 38-51). Spectrum sensing is only defined for portable TVBDs. A fixed TVBD may operate as part of a communication system so that it transmits to at least one other fixed TVBD or to at least one personal portable TVBD. A mode I portable device does not use an internal geolocation positioning capability and accesses a TV bands database. It must obtain a channel list from either a fixed TVBD or Mode II portable TVBD. A mode II portable device comprises similar functions as a fixed TVBD, but it does not need to transmit or receive signals at a specified and fixed geographic position. A particular concern is that associated with the different types and modes of TVDBs there are different transmission power upper limits. For a fixed TVBD, the maximum power delivered to a Transmission (TX) antenna must not exceed 1 W. For portable TVBDs, the maximum Effective Isotropic Radiated Power (EIRP) is 100 mW (20 dBm). If a portable TVBD does not meet the adjacent channel separation requirements, which means that the distance between the TVBD and the TV station is smaller than the minimum distance requirement, the maximum EIRP is 40 mW (16 dBm). The maximum power spectral densities, for any 100 kHz during any time interval of continuous transmission, for different types of TVBDs are: fixed devices 12.2 dBm, portable devices operating adjacent to occupied TV channels −1.6 dBm and a sensing only device −0.8 dBm. For all other portable devices the maximum power spectral density 2.2 dBm.

It would be beneficial to be able to use TV channels adjacent to an active TV channel for short-range communication in a mobile communication system. Short-range communication is possible with lower power such that upper limits imposed on transmission power are not exceeded. The use of transmission power limited bands for short range transmission would increase the overall data transmission capacity in the mobile communication system and avoid causing interference in adjacent active channels reserved for other types of communication systems, for example, TV broadcast systems.

### SUMMARY OF THE INVENTION

According to an aspect of the invention, the invention is a method, comprising: receiving at a mobile node at least one synchronization signal from a base station; determining timing at the mobile node based on the at least one synchronization signal from the base station; transmitting an uplink radio resource reservation request to the base station from the mobile node; receiving from the base station an assignment of a radio resource dedicated for radio transmission to a remote node, the radio resource being within a band having a transmission power upper limit; and transmitting a first data signal to the remote node on the radio resource based on the timing determined.

According to a further aspect of the invention, the invention is a method, comprising: transmitting at least one synchronization signal to a mobile node; receiving a communication set-up request from the mobile node, the request comprising an identifier of a remote party, the identifier of the remote party being associated with a remote node; determining that the remote party uses the remote node, the remote node being served by the base station; receiving, at the base station, an uplink radio resource reservation request from the mobile node; and transmitting from the base station an assignment of a radio resource dedicated for radio transmission to the remote node, the radio resource being within a band having a transmission power upper limit.

According to a further aspect of the invention, the invention is an apparatus comprising: at least one radio frequency circuit configured to receive at least one synchronization signal from a base station, to determine timing based on the at least one synchronization signal from the base station, and to transmit a first data signal to a remote node on a radio resource based on the timing determined; and at least one processor configured to transmit an uplink radio resource reservation request to the base station, to receive from the base station an assignment of the radio resource dedicated for radio transmission to the remote node, the radio resource being within a band having a transmission power upper limit.

According to a further aspect of the invention, the invention is a base station comprising: at least one radio frequency circuit configured to transmit at least one synchronization signal to a mobile node; and at least one processor configured to receive a communication set-up request from the mobile node, the request comprising an identifier of a remote party, the identifier of the remote party being associated with a remote node, to determine that the remote party uses the remote node, the remote node being served by the base station, to receive an uplink radio resource reservation request from the mobile node, and to transmit an assignment of a radio resource dedicated for radio transmission to the remote node, the radio resource being within a band having a transmission power upper limit.

According to a further aspect of the invention, the invention is an apparatus comprising: means for receiving at a mobile node at least one synchronization signal from a base station; means for determining timing at the mobile node based on the at least one synchronization signal from the base station; transmitting an uplink radio resource reservation request to the base station from the mobile node; means for receiving from the base station an assignment of a radio resource dedicated for radio transmission to a remote node, the radio resource being within a band having a transmission power upper limit; and means for transmitting a first data signal to the remote node on the radio resource based on the timing determined.

According to a further aspect of the invention, the invention is a base station comprising: means for transmitting at least one synchronization signal to a mobile node; means for receiving a communication set-up request from the mobile node, the request comprising an identifier of a remote party, the identifier of the remote party being associated with a remote node; means for determining that the remote party uses the remote node, the remote node being served by the base station; means for receiving, at the base station, an uplink radio resource reservation request from the mobile node; and means for transmitting from the base station an assignment of a radio resource dedicated for radio transmission to the remote node, the radio resource being within a band having a transmission power upper limit.

According to a further aspect of the invention, the invention is an apparatus, comprising: at least one processor configured to receive at least one synchronization signal from a base station, to determine timing based on the at least one synchronization signal from the base station, to transmit an uplink radio resource reservation request to the base station from the mobile node, to receive from the base station an assignment of a radio resource dedicated for radio transmission to a remote node, the radio resource being within a band having a transmission power upper limit, and to transmit a first data signal to the remote node on the radio resource based on the timing determined.

According to a further aspect of the invention, the invention is a computer program comprising code adapted to cause the following when executed on a data-processing system: receiving at a mobile node at least one synchronization signal from a base station; determining timing at the mobile node based on the at least one synchronization signal from the base station; transmitting an uplink radio resource reservation request to the base station from the mobile node; receiving from the base station an assignment of a radio resource dedicated for radio transmission to a remote node, the radio resource being within a band having a transmission power upper limit; and transmitting a first data signal to the remote node on the radio resource based on the timing determined.

According to a further aspect of the invention, the invention is a computer program product comprising the computer program.

According to a further aspect of the invention, the invention is a computer program comprising code adapted to cause the following when executed on a data-processing system: transmitting at least one synchronization signal to a mobile node; receiving a communication set-up request from the mobile node, the request comprising an identifier of a remote party, the identifier of the remote party being associated with a remote node; determining that the remote party uses the remote node, the remote node being served by the base station; receiving, at the base station, an uplink radio resource reservation request from the mobile node; and transmitting from the base station an assignment of a radio resource dedicated for radio transmission to the remote node, the radio resource being within a band having a transmission power upper limit.

According to a further aspect of the invention, the invention is a computer program product comprising the computer program.

In one embodiment of the invention, the at least one synchronization signal comprises at least one downlink symbol on at least one subcarrier.

In one embodiment of the invention, determining timing based on the at least one synchronization signal from the base station comprises determining at least one of a slot boundary, a subframe boundary, a frame boundary and a symbol boundary in time domain, for example, by the at least one radio frequency circuit of the mobile node. The symbol may be an OFDMA symbol. The boundaries may be seen as observed at the mobile node with the downlink delay. Thus, the timing may be seen to have a time offset of the downlink delay.

In one embodiment of the invention, determination timing based on the at least one synchronization signal from the base station comprises determining at least one of a slot boundary, a subframe boundary, a frame boundary and symbol boundary in time domain for at least one downlink radio resource from the base station. The at least one downlink radio resource comprises at least one resource block. From the at least one of the slot boundary, the subframe boundary, the frame boundary and the symbol boundary in time domain for at least one downlink radio resource is determined at least one of a slot boundary, a subframe boundary, a frame boundary and a symbol boundary in time domain for transmitting the first data signal to the remote node on the radio resource. The timing determined comprises the at least one of the slot boundary, the subframe boundary, the frame boundary and the symbol boundary in time domain for transmitting the first data signal to the remote node. The boundaries may be seen as observed at the mobile node.

In one embodiment of the invention, during downlink time when a downlink signal may be received from the base station to the mobile node, the timing is determined also based on a potential downlink signal. The timing may be based on particular points in the downlink signal such as, for example, a symbol boundary, a slot boundary, a subframe boundary, a frame boundary or any point during a potential downlink transmission. Downlink transmission may be intermittent or absent at certain time intervals. By downlink time may be meant, for example, a downlink subframe a downlink pilot time slot. The propagation delay between mobile node and the remote node may be ignored.

In one embodiment of the invention, during uplink time when an uplink signal may be transmitted from the mobile node to base station, the timing is determined also based on the potentially transmitted uplink signal. The timing may be based on particular points in the uplink signal such as, for example, a symbol boundary, a slot boundary, a subframe boundary, a frame boundary or any point during uplink transmission. By uplink time may be meant, for example, an uplink subframe or an uplink pilot time slot. The propagation delay between mobile node and the remote node may be ignored.

In one embodiment of the invention, the mobile node deactivates the TA (Timing Advance) value when transmitting to the remote node. Similarly, the remote node may deactivate its TA when transmitting to the mobile node.

In one embodiment of the invention, the at least one synchronization signal comprises a group of orthogonal frequency division multiple access resource elements which may be on adjacent subcarriers or on adjacent symbols.

In one embodiment of the invention, the timing determination may be performed periodically at predefined periods, for example, by the at least one radio frequency circuit. The timing determination may be performed while receiving downlink symbols from the base station.

In one embodiment of the invention, at least one of the at least one radio frequency circuit and the at least one processor of the mobile node transmitting a communication set-up request from the mobile node, the request comprising an identifier of a remote party, the identifier of the remote party being associated with the remote node.

In one embodiment of the invention, at least one of the at least one radio frequency circuit and the at least one processor of the mobile node, is further configured to transmitting at least one test signal between the mobile node and the remote node to determine whether the mobile node and the remote node are within a range providing sufficient radio quality for communication between the mobile node and the remote node.

In one embodiment of the invention, at least one of the at least one radio frequency circuit and the at least one processor of the mobile node, is further configured to receive from the base station a request to execute the transmission of the at least one test signal and to report a quality of reception of the at least one test signal to the base station.

In one embodiment of the invention, at least one of the at least one radio frequency circuit and the at least one processor of the mobile node, is further configured to switch to reception on the radio resource in the mobile node and to receive a second data signal from the remote node to the mobile node on the radio resource.

In one embodiment of the invention, at least one of the at least one radio frequency circuit and the at least one processor of the mobile node, is further configured to transmitting the first data signal and the second data signal using a orthogonal frequency division multiple access transmitter.

In one embodiment of the invention, at least one of the at least one radio frequency circuit and the at least one processor of the mobile node, is further configured to transmitting the first data signal and the second data signal using a single carrier frequency division multiple access transmitter.

In one embodiment of the invention, at least one of the at least one radio frequency circuit and the at least one processor of the mobile node, is further configured to receiving from the base station a request to stop using the radio resource at the mobile node.

In one embodiment of the invention, at least one of the at least one radio frequency circuit and the at least one processor of the mobile node, is further configured to receiving from the base station an assignment of an uplink radio resource for communication to the base station and to continue communication with the remote node using the uplink radio resource.

In one embodiment of the invention, at least one of the at least one radio frequency circuit and the at least one processor of the mobile node, is further configured to transmit the first data signal in a first slot of a subframe preceding a physical broadcast channel and to switch to receiving the physical broadcast channel from the base station during a second slot of the subframe preceding a physical broadcast channel.

In one embodiment of the invention, the mobile node comprises a Long-Term Evolution (LTE) User Equipment.

In one embodiment of the invention, the transmitting of the first data signal or the second data signal during a special subframe is restricted to have a duration corresponding to the length of a downlink pilot time slot.

In one embodiment of the invention, the remote node is a remote mobile node, for example an LTE User Equipment (UE). The remote node may also be a desktop, a desk computer or a server.

In one embodiment of the invention, the radio resource dedicated for radio transmission to the remote node is within a television white space band which is adjacent to an occupied or an active television channel. The uplink radio resource reservation request may be a radio resource reservation request transmitted in uplink direction to the base station. The reservation may concern a radio resource to be used for radio transmission to the remote node. Thus, the at least one processor at the mobile node may be configured to request the radio resource from the base station and in response to receive the assignment from the base station.

In one embodiment of the invention, the step of determining that the remote party uses the remote node further comprises transmitting the communication set-up request to a core network node; and receiving an indication of the communication set-up request to the base station from the core network node, the indication comprising an identifier of the remote node.

In one embodiment of the invention, the method comprises determining that the remote node is within a transmission range of the mobile node. This may be executed by at least one of the at least one radio frequency circuit and the at least one processor of the base station.

In one embodiment of the invention, the step of determining that the remote node is within a transmission range of the mobile node further comprises transmitting from the base station a request to execute the transmission of at least one test signal between the mobile node and the remote node; and receiving a report of a quality of reception of the at least one test signal to the base station.

In one embodiment of the invention, the determination that the remote node is within a transmission range of the mobile node uses at least one of a satellite positioning system, a geographic positioning system of a mobile communication system, and a determination of a sector of the mobile node and the remote mobile node.

In one embodiment of the invention, the symbols are OFDMA or Single Carrier Frequency Division Multiple Access (SC-FDMA) symbols.

In one embodiment of the invention, the mobile node comprises a Long-Term Evolution (LTE) User Equipment. At least one processor in the mobile node may be configured to perform the method steps disclosed hereinabove. The transmission, reception and timing related method steps may be performed by the at least one radio frequency circuit.

In one embodiment of the invention, the base station is an apparatus comprising a number of base station receivers and/or transmitters and a base station node. The base station node may be a base station server or a central unit.

In one embodiment of the invention, the at least one radio frequency circuit of the base station is comprised in a base station receiver and the at least one processor of the base station is comprised in a base station node. The base station receiver may also comprise a transmitter.

In one embodiment of the invention, the base station comprises an Evolved UMTS Radio Access Network (E-UTRAN) node such as, for example, an Evolved NodeB. At least one processor in the base station node may be configured to perform the method steps disclosed hereinabove. The transmission and reception may be performed by the at least one radio frequency circuit.

In one embodiment of the invention, the base station comprising a channel detection processor configured to determine channels of a television radio band which are free of signal transmission and channels with active signal transmission. The base station may also comprise a channel or frequency band database or a communication interface to remote database for such purpose from which channel availability may be determined, for example, using the location of the base station.

In one embodiment of the invention, the communication that is set-up may be a connection, for example, a transport layer connection, such as, for example, a TCP connection or a Stream Control Transmission Protocol (SCTP) connection. The communication may also be a flow of individual packets, for example, a flow of UDP packets. The flow of UDP packets may represent, for example, a media component associated with a multimedia session. In one embodiment of the invention, the communication may be set-up or established on any protocol layer, for example, it may be established, for example, also on Point-To-Point Protocol (PPP) layer or on a logical link layer.

In one embodiment of the invention, the base station comprises an OFDMA radio network node or an SC-FDMA radio network node.

In one embodiment of the invention, the at least one Radio Frequency (RF) circuit in the mobile node may also be referred to as at least one circuit.

In one embodiment of the invention, the at least one Radio Frequency (RF) circuit in the base station node may also be referred to as at least one circuit.

In one embodiment of the invention, the mobile node such as a User Equipment (UE) comprises a mobile station or generally a mobile terminal. In one embodiment of the invention a user of a mobile terminal is identified using a subscriber module, for example, User Services Identity Module (USIM) or a Subscriber Identity Module (SIM). The combination of Mobile Equipment (ME) and a subscriber module may be referred to as a mobile subscriber. A mobile subscriber may be identified using an IMSI. An IP address may be allocated or associated with a mobile subscriber.

In one embodiment of the invention, identifier of the remote party being associated with a remote node comprises that the identifier of the remote party is allocated for the remote node. The identifier of the remote node may be an address allocated for the remote node. The address allocation may be performed, for example, by an address allocation server. The address may be stored in a Packet Data Network Gateway (P-GW). The address may be used to route packets to the remote node via the P-GW. The address may be an IP address, for example, an IPv4 or IPv6 address.

In one embodiment of the invention, the remote party identifier is or comprises a mobile subscriber identity, for example, the International Mobile Subscriber Identity (IMSI).

In one embodiment of the invention, the remote party identifier is or comprises an identifier or an address of the remote party, for example, a Uniform Resource Identifier, a Mobile Subscriber ISDN (MSISDN) number, a logical name, a name, an E-mail address or any other identity.

In one embodiment of the invention, the apparatus is a mobile terminal, for example a, mobile handset.

In one embodiment of the invention, the apparatus is a semiconductor circuit, a chip or a chipset.

In one embodiment of the invention, the base station node is configured to be used in a 4G system such as, for example, LTE Evolved Packet System (EPS).

In one embodiment of the invention, the computer program is stored on a computer readable medium. The computer readable medium may be, but is not limited to, a removable memory card, a removable memory module, a magnetic disk, an optical disk, a holographic memory or a magnetic tape. A removable memory module may be, for example, a USB memory stick, a PCMCIA card or a smart memory card.

In one embodiment of the invention, the computer program product is stored on a computer readable medium. The computer readable medium may be, but is not limited to, a removable memory card, a removable memory module, a magnetic disk, an optical disk, a holographic memory or a magnetic tape. A removable memory module may be, for example, a USB memory stick, a PCMCIA card or a smart memory card.

The embodiments of the invention described hereinbefore may be used in any combination with each other. Several of the embodiments may be combined together to form a further embodiment of the invention. A method, a base station, an apparatus, a computer program or a computer program product to which the invention is related may comprise at least one of the embodiments of the invention described hereinbefore.

It is to be understood that any of the above embodiments or modifications can be applied singly or in combination to the respective aspects to which they refer, unless they are explicitly stated as excluding alternatives.

The benefits of the invention are related to enhanced data transmission capacity in a mobile communication system and the avoiding of interference in frequency bands immediately adjacent to a frequency band allocated for another type of communication system.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a cell and two communicating mobile nodes within a mobile communication system in one embodiment of the invention;

FIG. 2 is a message sequence chart illustrating device-to-device communication establishment in a mobile communication system in one embodiment of the invention;

FIG. 3A illustrates a spectrum allocation with balanced uplink-downlink bandwidth in one embodiment of the invention;

FIG. 3B illustrates a spectrum allocation with unbalanced uplink-downlink bandwidth in one embodiment of the invention;

FIG. 4 is a flow chart illustrating a method for device-to-device communication in a mobile node in one embodiment of the invention;

FIG. 5 is a flow chart illustrating a method for device-to-device communication establishment in one embodiment of the invention;

FIG. 6 illustrates an apparatus in one embodiment of the invention; and

FIG. 7 illustrates a timing of device-to-device communication in one embodiment of the invention.

### DETAILED DESCRIPTION OF THE EMBODIMENTS

Reference will now be made in detail to the embodiments of the present invention, examples of which are illustrated in the accompanying drawings.

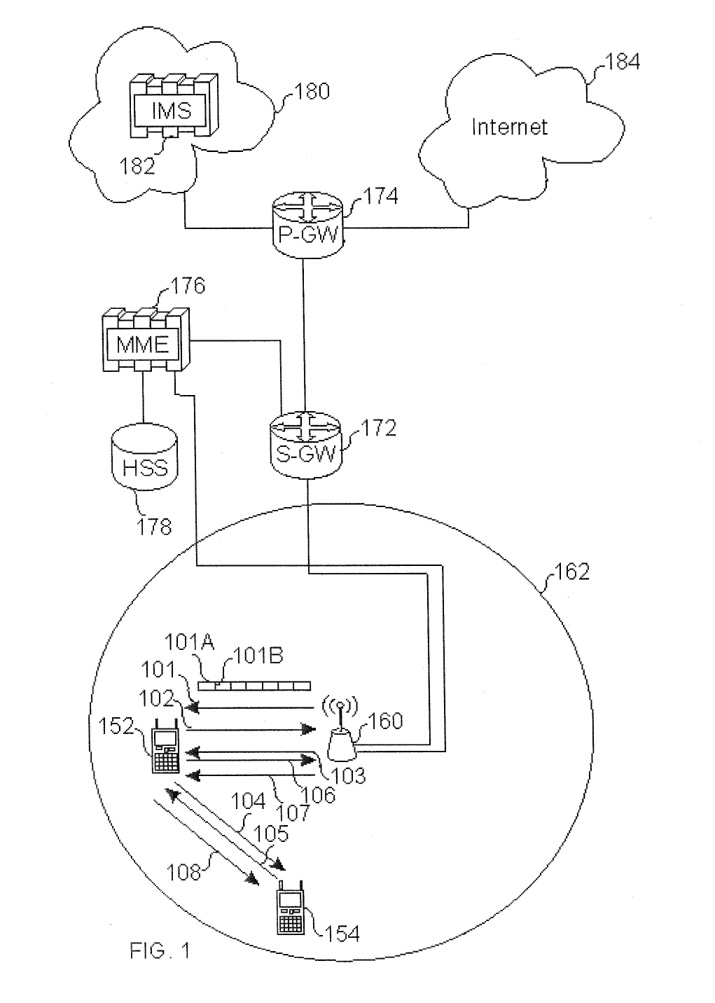

FIG. 1 illustrates a cell and two communicating mobile nodes within a mobile communication system in one embodiment of the invention. FIG. 1 illustrates a base station 160 providing a cell 162. The cell may be comprised in an LTE mobile communication system, comprising, for example, an Evolved UMTS Radio Access Network (E-UTRAN). In FIG. 1 there is only illustrated base station 160 from the E-UTRAN. There may be a plurality of other base station together with their cells. Base station 160 in E-UTRAN parlance is called an Evolved Node B (eNB). Base station 160 may comprise at least one Remote Radio Heads (RRH) (not shown) communicating with a base station server within base station 160. In the area of cell 162 there is a mobile node 152 and a mobile node 154. The mobile nodes may also be referred to as User Equipments (UE), mobile stations or mobile terminals. Mobile nodes 152 and 154 are configured for device-to-device transmission. By device-to-device transmission is meant, for example, radio communication occurring directly between devices such as UEs, which may also receive downlink transmissions from a base station such as base station 160. In FIG. 1 base station 160 is communicatively connected to a Core Network (CN), more precisely, to a Serving Gateway (S-GW) 172 and a Mobility Management Entity (MME) 176. S-GW 172 is communicatively connected to a Packet Data Network Gateway (P-GW) 174, which is communicatively connected to an IP network 184 and to an IP Multimedia Subsystem (IMS) 180 and therein to an IMS node 182.

In LTE an eNB, such as base station 160, performs radio resource management, comprising radio bearer control, radio admission control, connection mobility control and dynamic allocation of resources to UEs such as mobile node 152 and mobile node 154. An eNB also performs IP header compression and encryption of user plane data traffic. An eNodeB selects an MME, such as MME 176, at UE attachment when no routing to an MME can be determined from the information provided by a UE at the time of the attachment. An eNB also performs mobility management signaling with MME. It routes a user plane data towards an S-GW such as S-GW 172. An MME performs mobility management related functions. The MME performs tracking area list management, selects an S-GW and a P-GW, such as P-GW 174, for a UE. It selects MME in association with handovers. The S-GW acts as local mobility anchor point for inter eNB handover. It performs packet routing and forwarding towards eNBs. The S-GW also performs E-UTRAN idle mode downlink packet buffering and initiation of network trigged service requests. It also performs transport level packet marking in the uplink and the downlink directions. It also performs accounting and charging. A P-GW on the other hand performs UE IP address allocation for UEs. P-GW maintains information on Evolved Packet Service (EPS) bearers associated with a UE. P-GW is the highest level mobility anchor in an LTE network. The P-GW performs per user based package filtering by the package inspection. The P-GW performs transport level package marking in the downlink. The P-GW generally acts as an interface towards an external IP-NW such as the internet or an intranet. The IMS 180 performs the establishment of multimedia sessions between UEs or toward an external IP multimedia system, for example, a Voice-Over IP (VoIP) system (not shown).

The starting point in FIG. 1 is that base station 160 has in its use a permitted frequency band which has at least an adjacent frequency band in use on at least one side of the permitted frequency band. The adjacent frequency band is used by another system, for example, a broadcast system. The adjacent frequency band may have a higher boundary frequency or lower boundary frequency that the permitted frequency band. Within the permitted frequency band there is a transmission power restricted band adjacent to the adjacent frequency band. The transmission power restricted band may be seen as a guard band, but it is not completely devoid of signals as many typical guard bands. The permitted frequency band may comprise, for example, at least three TV channels. The permitted frequency band may comprise four TV white space channels, for example, so that the four TV white space TV channels are flanked in the frequency domain by TV channels in active use or TV channels which may enter into active use so that the transmission power restrictions on adjacent white space TV channels are in force.

Initially, mobile node 152 receives at least one synchronization signal from base station 160, as illustrated with arrow 101. The at least one synchronization signal may be received in a slot 101A, which comprises a number of symbols such as symbol 101B. The synchronization signal comprises, for example, at least one bit pattern. Mobile node 152 determines timing based on the at least one synchronization signal from base station 160. The timing is required, in addition to receiving transmissions from base station 160, for device-to-device transmission to an arbitrary remote node to which may be transmitted using a power that falls within the transmission power upper limits of the transmission power restricted band. For example, in the case of LTE the at least one synchronization signal comprises a Primary Synchronization Signal (PSS) and a Secondary Synchronization Signal (SSS). The PSS assists in subframe timing determination and in the determination of exact carrier frequency, whereas SSS assists in frame timing determination. The PSS and SSS are transmitted in different symbols on same subcarriers. By the successful reading of PSS and SSS, mobile node 152 is able to receive and read successfully the Physical Broadcast Channel (PBCH) transmitted from base station 160. This enables mobile node 152 to obtain broadcasted system information and read Physical Downlink Control Channel (PDCCH) and Physical Downlink Shared Channel (PDSCH) transmitted by base station 160. Thereupon, mobile node 152 performs attachment to E-UTRAN. In the attachment mobile node 152 performs registration (not shown) to the MME 176 and S-GW 172. The attachment involves the establishing of a default Evolved Packet System (EPS) bearer to P-GW 174 via S-GW 172. The default EPS bearer provides Quality of Service (QoS) sufficient for signaling purposes, for example, towards IMS node 182.

At a later stage mobile node 152 determines that it needs to communicate with a remote entity, such as a user or node, which is identified with a remote party identifier. The remote party identifier may be an Internet Protocol (IP) address, which may be obtained with Domain Name System (DNS) resolution using a domain name. The remote party identifier may also be a user identifier such as a Session Initiation Protocol (SIP) Uniform Resource Identifier (URI), a TEL-URI, a URI, a Uniform Resource Locator (URL), an E-mail address or an E.164 address. Mobile node 152 sends a communication set-up request comprising the remote party identifier to base station 160, as illustrated with arrow 102. The communication set-up request may be a request to establish a TCP connection, that is, a TCP SYN packet. The communication set-up request may be a request to establish a SIP session to the remote party. The communication set-up request may be a request to establish any transport layer connection or any session to the remote party. Base station 160 may also page (not shown) mobile node 154, if mobile node 154 is in detached state. In response to a paging from base station 160 to mobile node 154, base station 160 receives a paging response (not shown), which indicates that mobile node 154 is in the area of cell 162.

In response to receiving the communication set-up request or the paging response, base station 160 determines that mobile node 152 and 154 belong to the same cell, namely cell 162. The determination may involve routing the communication set-up request via the core network, for example, via S-GW 172 and P-GW 174 back to base station 160. Base station 160 sends a request to mobile node 152, as illustrated with arrow 103, which causes mobile node 152 to attempt to reach mobile node 154 using direct device-to-device transmission. The request for attempt comprises information on a test radio resource to be used for the test transmission. The test radio resource may comprise a number of symbols and subcarriers. Mobile node 152 transmits a test signal to mobile node 154 using the radio resource, as illustrated with arrow 104. If mobile node 154 is capable of receiving correctly the test signal, it responds with a test response signal, as illustrated with arrow 105. Mobile node 152 sends a report of the success of the test signal transmission between mobile node 152 and mobile node 154 to base station 160, as illustrated with arrow 106. The report may comprise radio quality information pertaining to the test signal transmission in both directions. The report may comprise an indication whether the test signal transmission is successful using radio quality criteria determined in at least one of mobile node 152 or at mobile node 154. If the radio quality indicated in the report is determined sufficient or if the report indicates successful transmission, base station 160 issues an assignment to mobile node 152 for a radio resource to be used in the actual device-to-device data communication, as illustrated with arrow 107. The data communication radio resource may comprise a number of symbols and subcarriers. The assignment may comprise an indication that a radio bearer established for transmitting the communication set-up request between mobile node 152 and base station 160 must be released by at least one of the base station 160 or mobile node 152. Base station 160 may also forward the communication set-up request (not shown) to mobile node 152 in a message comprising an indication that the communication set-up request must be relayed to mobile node 154 using the radio resource assigned. The fact that mobile node 152 may relay the communication set-up request to mobile node 154 bears the advantage that protocol semantics regarding the protocol layer of the communication set-up request are not broken as the result of the change of the uplink radio bearer for user plane data associated with the communication set-up request to the radio resource for device-to-device data communication. Finally, the communication between mobile node 152 and mobile node 154 is initiated, as illustrated with arrow 108.

In one embodiment of the invention, base station 160 transmits the communication set-up request to mobile node 154 using a radio bearer established between mobile node 154 and base station 160. By the time the test transmission between mobile node 152 and mobile node 154 is indicated as successful to base station 160, base station 160 issues an assignment commanding mobile node 152 and mobile node 154 to start using a radio resource for device-to-device data communication. The radio bearer between mobile node 152 and base station 160 and the radio bearer between mobile node 154 and base station 160 are kept reserved as long as all data packets en route via base station 160, S-GW 172 and P-GW 174 between mobile node 152 and mobile node 154 are still in transit, that is, they have not been received at their destinations. This embodiment may also be applied in case during an existing communication between mobile node 152 and mobile node 154 is switched to use a radio resource for device-to-device data communication, as a result of the successful test transmission between these mobile nodes.

In one embodiment of the invention, when base station 160 issues an assignment commanding mobile node 152 and mobile node 154 to start using a radio resource for device-to-device data communication, the radio resources between mobile node 152 and base station 160 and the radio resources between mobile node 152 and base station 160 being replaced with the radio resource for device-to-device communication are released and all packets in transit between mobile node 152 and mobile node 154 are dropped, for example, at base station 160. This will be treated as dropped packets in the protocol layer association with the communication set-up request, for example, TCP.

In one embodiment of the invention, mobile node 152 may determine before the transmitting of the communication set-up request to base station 160 initially that the remote party for the communication uses a mobile node, for example, mobile node 154 which is within the same cell 162. This may be implemented so that mobile node 152 executes at least one message exchange with the remote party, which reveals to at least one of mobile node 152 or base station 160 the fact that mobile node 154 is within the same cell 162 together with mobile node 152. Such a message exchange may be, for example, use the Internet Control Message Protocol (ICMP) Echo packet and the ICMP Echo reply packet.

In one embodiment of the invention, an actual transport layer communication set-up request is not sent to base station 160 from mobile node 152. Instead, the communication set-up request illustrated with arrow 102 is a mere enquiry of a possibility to establish a device-to-device communication between mobile node 152 and mobile node 154. The enquiry may comprise an identifier of the remote party, the identifier of the remote party being associated with mobile node 154. In this case, the purpose of the sending of an uplink radio resource reservation request from the mobile node 152 to base station 160 is for network attachment, which may be performed before the sending of the communication set-up request to the base station 160.

In one embodiment of the invention, base station 160, mobile node 152 and mobile node 154 are TV Band Devices (TVBD). A TVBD may be defined as an unlicensed intentional radiator, which is operating on available channels in the broadcast television frequency bands, for example, at 54-60 MHz, 76-88 MHz, 174-216 MHz, 470-608 MHz and 614-698 MHz bands. A fixed TVBD such as, for example, base station 160, is not allowed to use an adjacent channel of an active TV channel. Mobile node 152 or mobile node 154 may be a mode I or a mode II portable, that is, personal devices.

In one embodiment of the invention, base station 160 comprises a TV band database. The TV band database may maintain records of all authorized services in the TV frequency bands. It may be capable of determining available TV channels at a specific geographic location and it may provide a list of available channels to another TVBD. In one embodiment of the invention, a TV band database is located in a remote core network node, for example, in MME 176, which base station 160 enquires in order to obtain the list of available channels.

It should be noted that the number of network elements in FIG. 1 is just for illustrative purposes. There may be any number of network elements illustrated in FIG. 1.

The embodiments of the invention described hereinbefore in association with FIG. 1 may be used in any combination with each other. Several of the embodiments may be combined together to form a further embodiment of the invention.

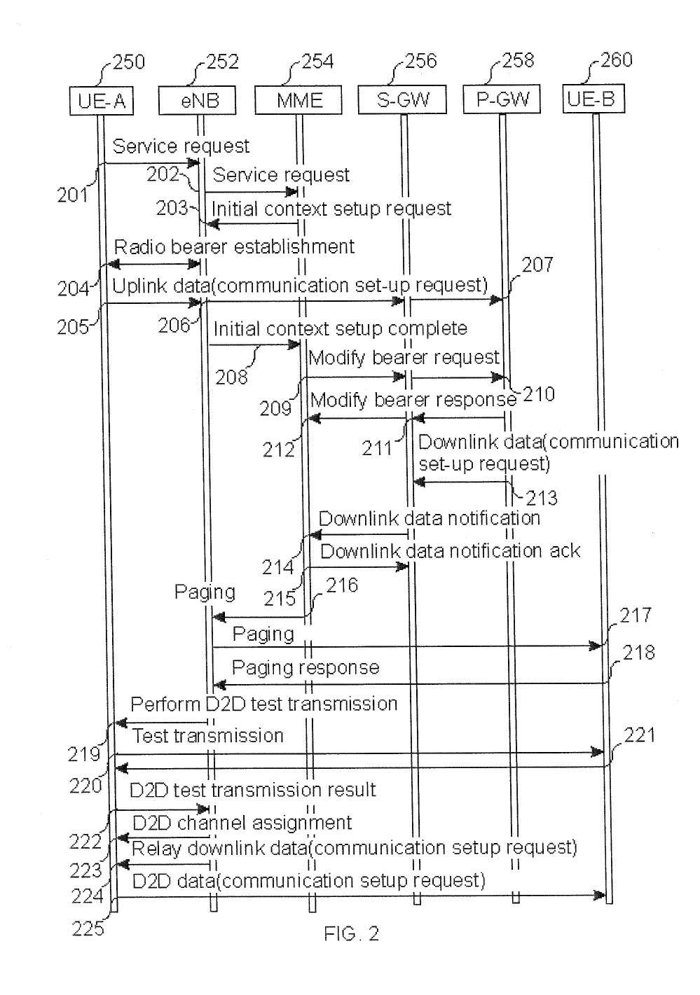

FIG. 2 is a message sequence chart illustrating device-to-device communication establishment in a mobile communication system in one embodiment of the invention.

In FIG. 2 there is a mobile node 250, for example, an LTE UE. There is also a base station 252, for example, an E-UTRAN Evolved Node B (eNS) 252. There is also a Mobility Management Entity (MME) 254, a Serving Gateway (S-GW) 256 and a Packet Data Network Gateway (P-GW) 258. There is also a remote mobile node 260, for example, an LTE UE. In one embodiment of the invention, the network elements in FIG. 2 correspond to the respective network elements of FIG. 1.

The starting point in FIG. 2 is that mobile node 250 performs an attach procedure to LTE Core Network (CN) via base station 252 and thereby to MME 254. Similarly, it may be assumed that mobile node 260 also separately performs an attach procedure to MME 254 within an LTE CN via base station 252. MME 254 selects S-GW 256 and P-GW 258, for both mobile nodes in the case of FIG. 2. MME 254 creates a default EPS bearer to S-GW 256 with a create session request. The create session request is sent further from S-GW 256 to P-GW 258. Entries are created in EPS bearer context table of S-GW 256 for mobile node 250 and mobile node 260. An EPS bearer context table entry in S-GW 256 comprises, for example, the International Mobile Subscriber Identities (IMSI) for a mobile subscriber associated with a mobile node, a last known cell identifier for the mobile node, the address of P-GW 258, as obtained in response to session creation request, and the address of MME 254. Similarly, entries are created in EPS bearer context table of P-GW 258 for mobile node 250 and mobile node 260. An EPS bearer context table entry in P-GW 258 comprises, for example, a Tunnel Endpoint Identifier (TEID), S-GW 256 address, QoS information and a Traffic Flow Template (TFT). The entries allow P-GW 258 to route user plane packets to S-GW 256 and to apply QoS for user plane packets. A radio resource between mobile node 250 and base station 252 is also allocated with the QoS for the default EPS bearer.

In order to be able to register to LTE CN mobile node 250 and mobile node 260 must determine timing for downlink reception from base station 252, based on the at least one synchronization signal from base station 252. The synchronization signals may be PSS and SSS as explained in FIG. 1. This is performed to be able to perform the attach procedure. The timing is required also for device-to-device transmission to an arbitrary remote node to which may be transmitted using a power that falls within the transmission power upper limits of the transmission power restricted band. The attach procedure related signaling is not shown in FIG. 2 for clarity purposes.

A further starting point in FIG. 2 is that mobile node 250 determines that it must establish a communication to a remote party address, which is associated with mobile node 260. The communication to be established may be a connection, for example, a transport layer connection, such as, for example, a TCP connection or a Stream Control Transmission Protocol (SCTP) connection. The communication may also be a flow of individual packets, for example, a flow of UDP packets. The flow of UDP packets may represent, for example, a media components associated with a multimedia session. In one embodiment of the invention, the communication may be established on any protocol layer, for example, it may be established, for example, also on Point-To-Point Protocol (PPP) layer or on a logical link layer.

After the attachment and detecting the need to establish the communication, mobile node 250 sends a service request message to base station 252, as illustrated with arrow 201. The message may comprise, for example, an MME Temporary Mobile Subscriber Identity (M-TMSI) and an MME Code (MMEC), which together form a System Architecture Evolution (SAE) TMSI, that is, an S-TMSI. The message may be classified as a Non-Access Stratum (NAS) message. The service request message may be encapsulated in a Radio Resource Control (RRC) message. Base station 252 forwards the service request message to MME 254, as illustrated with arrow 202. The message may be classified as a Non-Access Stratum (NAS) message and it may be encapsulated in an initial UE message. Upon receiving the service request message, MME 254 may authenticate mobile node 252 and establish encryption and integrity protection. Thereupon, MME 254 sends an initial context setup request message to base station 252. A radio bearer is established between mobile node 250 and base station 252, as illustrated with double-headed arrow 204, since it involves a message exchange. User plane security is established at this phase. The radio bearer is established for user plane packet traffic. Mobile node 250 sends an uplink data packet to base station 252, as illustrated with arrow 205. The data packet comprises a communication set-up request for a communication between mobile node 250 and a remote party identifier with a remote party identifier, for example, a remote party IP-address, which may be an IPv4 or an IPv6 address. The data packet is forwarded from base station 252 to S-GW 256, as illustrated with arrow 206. The data packet and other uplink data packets from mobile node 250 may have already earlier been received to base station 252 and buffered therein, but they are forwarded to S-GW 256 at this stage. The data packet is send from S-GW 256 to P-GW 258 using the a General Packet Radio System (GPRS) Tunneling Protocol for User Plane (GTP-U) via the tunnel between S-GW 256 and P-GW 258, as illustrated with arrow 207. In response to radio bearer establishment for user plane packet traffic, base station 252 sends an initial context setup complete message to MME 254, as illustrated with arrow 208. The message comprises, for example, address for base station 252, TEID and a list of at least one accepted EPS bearer. MME 254 sends a modify bearer request message to S-GW 256, as illustrated with arrow 209. The message comprises, for example, address for base station 252, TEID and a list of at least one accepted EPS bearer. S-GW 256 is now able to transmit downlink user plane packets to base station 252. S-GW 256 may send a modify bearer request message to P-GW 258, as illustrated with arrow 210, for example, if there is a change in the location of mobile node 250. P-GW 258 sends a modify bearer response message to S-GW 256, as illustrated with arrow 211. S-GW sends a modify bearer response message to MME 254, as illustrated with arrow 212. In response to the data packet illustrated with arrow 207, which carries the communication set-up request, P-GW 258 determines that the remote party IP address refers to a mobile node within the same Evolved Packet Core (EPS) network, for example, using routing table lookup. This may also be performed in a further router connected to P-GW 258. As a result P-GW 258 routes the packet to S-GW 256 and sends the packet to S-GW 256, as illustrated with arrow 213. S-GW 256 sends a downlink data notification message to MME 254, as illustrated with arrow 214. MME 254 sends a downlink data notification acknowledgement message to S-GW 256, as illustrated with arrow 215. MME 254 issues a paging order to base station 252, as illustrated with arrow 216. Base station 254 sends a page to mobile node 260, as illustrated with arrow 217. Mobile node 260 responds to paging, as illustrated with arrow 218.

In response to receiving the paging response from mobile node 260, base station 252 determines that mobile node 250 and 260 to the same cell served by base station 252 and may be at a proximity which permits device-to-device radio communication, taking into considerations the upper transmit power limit for the band for the device-to-device radio communication. Base station 252 sends a request to perform device-to-device transmission testing to mobile node 250, as illustrated with arrow 219, which causes mobile node 250 to attempt to reach mobile node 260 using direct device-to-device radio transmission. The request comprises information on a test radio resource to be used for the test transmission. Mobile node 250 transmits a test signal to mobile node 260 using the radio resource, as illustrated with arrow 220. If mobile node 260 is capable of receiving correctly the test signal, it responds with a test response signal, as illustrated with arrow 221. Mobile node 250 sends a device-to-device test transmission result for the test transmissions between mobile node 250 and mobile node 260 to base station 252, as illustrated with arrow 222. The report may comprise radio quality information pertaining to the test signal transmission in both directions. The report may comprise an indication whether the test signal transmission is successful using radio quality criteria determined in at least one of mobile node 250 and mobile node 260. If the radio quality indicated in the report is determined sufficient or if the report indicates successful transmission, base station 252 issues a device-to-device channel assignment to mobile node 250 for a radio resource to be used in the actual device-to-device data communication to mobile node 260, as illustrated with arrow 223. The assignment may comprise an indication that the radio bearer established for the communication set-up request must be released by at least one of the base station 252 or mobile node 250. This may also be determined by mobile node 250 in response to the receiving of the assignment. Base station 252 may also forward the communication set-up request to mobile node 260 in a relay downlink data message, as illustrated with arrow 224. The message comprises an indication that the communication set-up request must be relayed to mobile node 260 using the radio resource assigned. Mobile node 250 send the communication setup request to mobile node 260, as illustrated with arrow 225. The device-to-device transmission may be the transmission of symbols, slots, frames or subframes comprising user plane data.

In one embodiment of the invention, the radio resource assigned for device-to-device communication uses LTE TDD transmission. The transmission may use OFDMA. The transmission may also use SC-FDMA in one embodiment of the invention.

In one embodiment of the invention, nearby mobile nodes having substantially low path loss to serving base station should be scheduled further from the reserved channels in frequency domain of corresponding downlink resources due to power leakage issues. Respectively devices having high path loss to serving base station could be scheduled closer to the downlink resources.

In one embodiment of the invention, the mobile node 250, upon receiving an assignment of a radio resource for device-to-device communication within a restricted transmission power band, during the corresponding downlink transmission, deactivates the TA (Timing Advance) value when transmitting to mobile node 260. When the TA value is deactivated, the mobile node 250 and mobile node 260 are in synch with corresponding downlink signal in their point of view. The Inter Symbol Interference (ISI) may be avoided. The mobile nodes may explicitly determine when to deactivate the TA utilizing the TDD configuration information and subframe number on scheduling grant from base station 252. A mobile node may configure itself into DRX state for downlink transmission while not trying to decode PDCCH of corresponding subframe.

The embodiments of the invention described hereinbefore in association with FIGS. 1 and 2 may be used in any combination with each other. Several of the embodiments may be combined together to form a further embodiment of the invention.

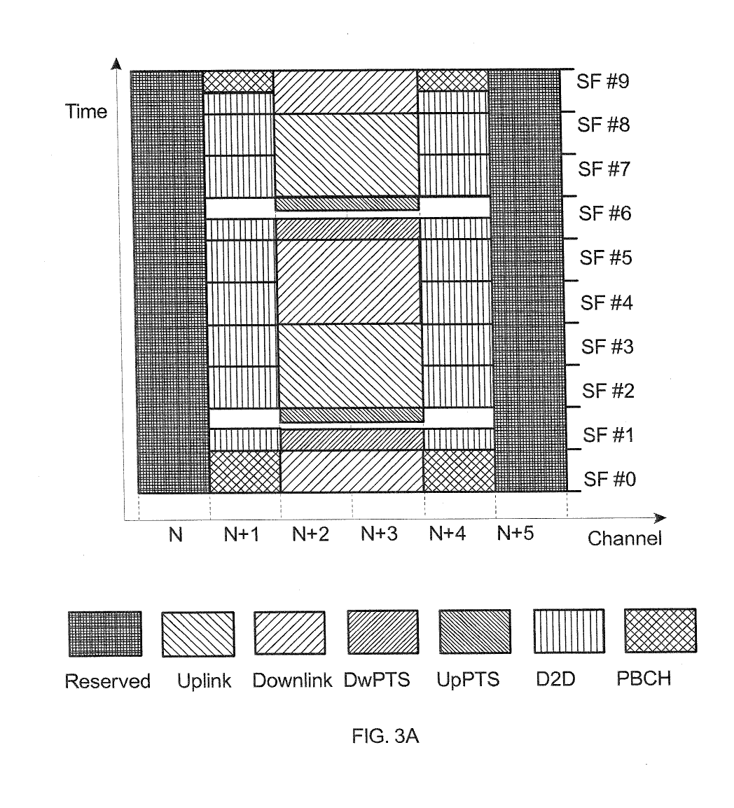

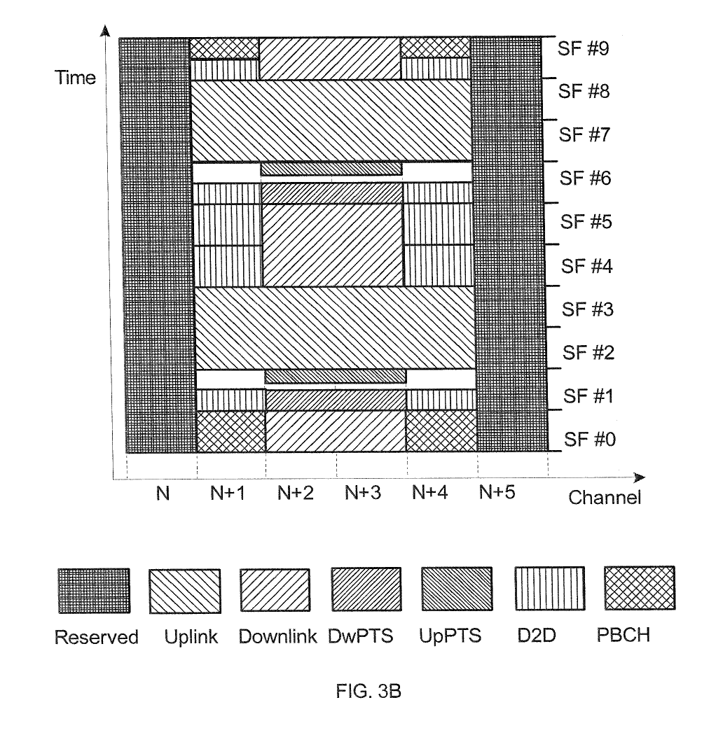

FIG. 3A illustrates a spectrum allocation with balanced uplink-downlink bandwidth in one embodiment of the invention. FIG. 3A illustrates channels, for example, TV channels on the X-axis, and time on the Y-axis. Channels N and N+6 are reserved, for example, for TV broadcasting. Channels N+1 and N+4 have an upper transmission power limit to avoid interference to channels N and N+5. Channels N+2 and N+3 are used for LTE TDD transmission between mobile node and base station, because they are sufficiently far from reserved channels N and N+5. The use of specific subframes for uplink or downlink transmission and the location and number of special subframes containing transmission/reception switching are dependent on a TDD configuration determined by the base station. A change in TDD configuration causes a change in the subframes and time periods possible for device-to-device radio communication. Subframes SF #8, SF #7, SF #3 and SF #2 on channels N+2 and N+3 are used for uplink transmission. Subframes SF #9, SF #5, SF #4 and SF #0 are used for downlink transmission. Subframes SF #6 and SF #1 are special subframes used for the change of transmission direction and comprise the Downlink Pilot Time Slot (DwPTS) and Uplink Pilot Time Slot (UpPTS) and Guard Period (GP) between them. Within the band-width of channels N+2 and N+3 there may be a plurality of TDD radio resources comprising at least one resource block with a number of subcarriers. Subframes SF #9 on channels N+1 and N+4 carry Physical Broadcast Channel (PBCH).

There may be certain considerations for a base station, when scheduling adjacent TV channel resources during the corresponding downlink transmission.

In one embodiment of the invention, during the subframe containing Physical Broadcast Channel (PBCH) the adjacent TV channel resources cannot be scheduled, which is the subframe SF #0. The reason is that the local communicating mobile nodes, for example, a device-to-device pair, need also listen to the system information provided by the network, for example, in a System Information Block (SIB).

In one embodiment of the invention, subframe SF #9 is skipped in device-to-device radio communication, because it may be difficult to use due to very fast Tx/Rx switching requirement in devices since PBCH reception is required in next subframe. In one embodiment of the invention, the base station may schedule the first slot of subframe SF #9 for device-to-device communication purposes thus providing also enough time for Tx/Rx switching.

In one embodiment of the invention, device-to-device transmission during special subframe should be restricted so that the duration at the maximum is the same with corresponding downlink transmission (not the entire subframe). The device-to-device transmission during the special subframes SF #1 and SF #6 may be timed to have the same period in time with the DwPTS. This is due to base station self protection against interference caused to the uplink transmissions of cellular UE devices since the device-to-device transmission is in synch with corresponding downlink transmission from the base station. If there is a scheduled uplink transmission or a local device-to-device transmission at the beginning of the uplink transmission period after the guard period, the local communicating UE devices may also need to switch from Rx to Tx or vice versa needing some guard time for such an operation and possible uplink TA for transmission.

In one embodiment of the invention, the UE devices having a valid resource grant for adjacent channel transmission cannot decode the PDCCH of corresponding subframe in DL so specific control signal transmission should be avoided. This is due to SC-FDMA receiver in use at Rx device. The UE devices can be configured into DRX state explicitly with the scheduling configuration. Path loss or Timing Advance (TA) value to serving base station of corresponding UE devices could be taken into account in resource allocation.

In one embodiment of the invention, nearby mobile nodes having substantially low path loss to serving base station should be scheduled further from the reserved channels in frequency domain of corresponding downlink resources due to power leakage issues. Respectively devices having high path loss to serving base station may be scheduled closer to the downlink resources.

In one embodiment of the invention, the mobile nodes, upon receiving a scheduling assignment on adjacent TV channel during the corresponding DL transmission, deactivate the possible TA (Timing Advance) value when transmitting. When the TA value is deactivated, the mobile nodes are in synch with corresponding downlink signal in local point of view so the Inter Symbol Interference (ISI) may be avoided. The mobile nodes may explicitly determine when to deactivate the TA utilizing the TDD configuration information and subframe number on scheduling grant from base station. A mobile node may configure itself into DRX state for downlink transmission while not decoding PDCCH of corresponding subframe.

In one embodiment of the invention, the local device, that is, mobile nodes utilize their OFDM-transmitter/receiver for communication in adjacent TV channels during corresponding downlink transmission. The reason is that the Rx device could use the LTE DL receiver for receiving. That would make possible also the PDCCH decoding of corresponding downlink transmission and receiving, for example, common control information for local, that is, device-to-device communication.

FIG. 3B illustrates a spectrum allocation with unbalanced uplink-downlink bandwidth in one embodiment of the invention. FIG. 3B illustrates channels, for example, TV channels on the X-axis, and time on the Y-axis. Channels N and N+5 are reserved, for example, for TV broadcasting. Channels N+1 and N+4 have an upper transmission power limit to avoid interference to channels N and N+5. Channels N+2 and N+3 are used for LTE TDD transmission between mobile node and base station. The use of specific subframes for uplink or downlink transmission and the location and number of special subframes containing transmission/reception switching are dependent on a TDD configuration determined by the base station. In FIG. 3A channels N+1, N+2, N+3 and N+4 are used for uplink transmission to a base station during subframes SF #8 and SF #7, and subframes SF #3 and SF #2.

The embodiments of the invention described hereinbefore in association with FIGS. 1, 2, 3A and 3B may be used in any combination with each other. Several of the embodiments may be combined together to form a further embodiment of the invention.

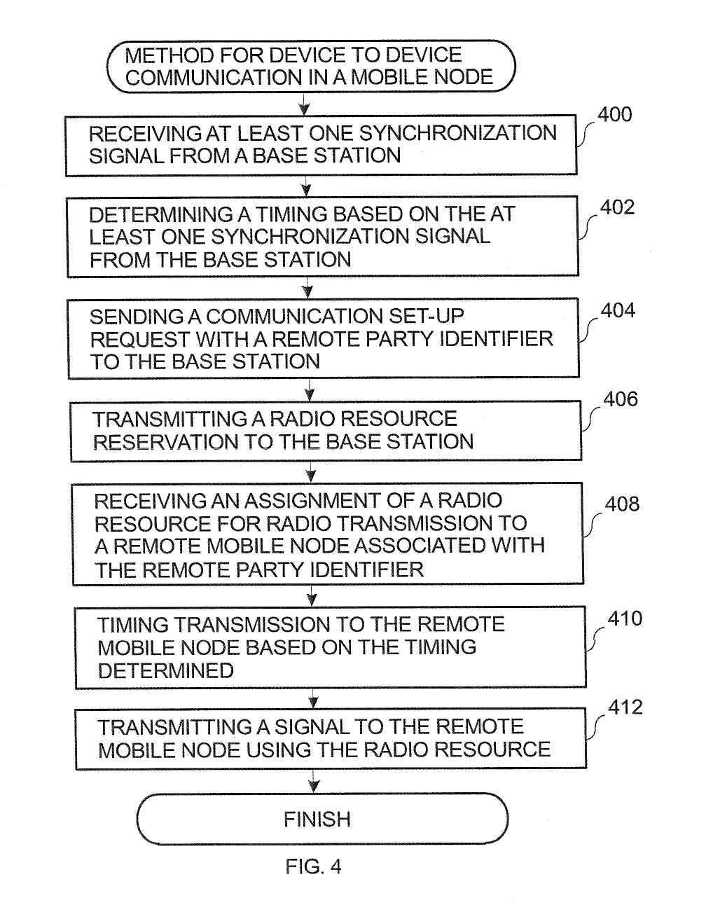

FIG. 4 is a flow chart illustrating a method for device-to-device communication in a mobile node in one embodiment of the invention.

At step 400 a mobile node receives at least one synchronization signal from a base station.

At step 402 the mobile node determines timing based on the at least one synchronization signal from the base station.

In one embodiment of the invention, the steps 400 and 402 may be repeated at later steps of the method, for example, during or between the transmitting of a signal or signals to a remote mobile node using a device-to-device communication radio resource.

At step 404 the mobile node may send a communication set-up request with a remote party identifier to the base station.

In one embodiment of the invention, the mobile node determines the possibility for device-to-device communication to the remote party without attempting to establish the communication via the core network, that is, via at least one router or other node in the core network.

At step 406 the mobile node transmits a radio resource reservation to the base station. The radio resource reservation may be a radio bearer establishment or an EPS bearer establishment request.

At step 408 the mobile node receives an assignment of a radio resource for radio transmission to a remote mobile node associated with the remote party identifier. The remote party identifier may be an IP address, for example, IPv4 or IPv6 address. The remote mobile node is associated with remote party identifier via a registration to the network, which associates the remote party identifier to an identifier of the mobile node. The mobile node may in turn be identified with a subscriber identity such as an IMSI. The subscriber identity may be associated with an apparatus via a card or a memory storing the subscriber identity.

At step 410 the mobile node times the transmission to the remote mobile node based on the timing determined.

At step 412 the mobile node transmits at least one signal to the remote mobile node using the radio resource.

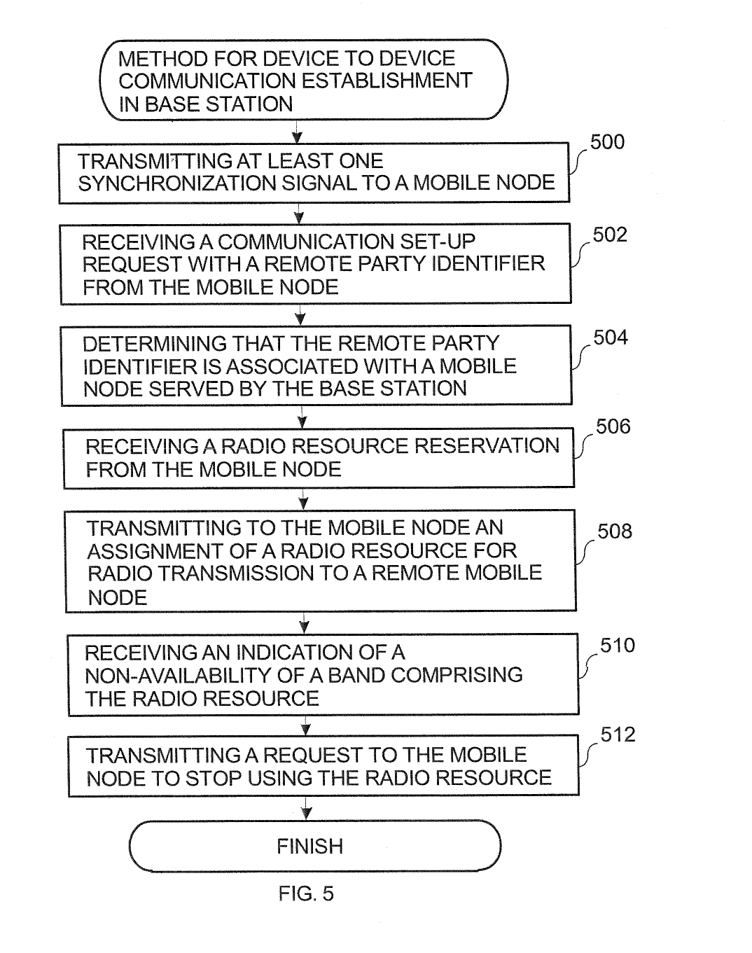

FIG. 5 is a flow chart illustrating a method for device-to-device communication establishment at a base station in one embodiment of the invention.

At step 500 the base station transmits at least one synchronization signal to a mobile node.

At step 502 the base station may receive a communication set-up request with a remote party identifier from the mobile node.

In one embodiment of the invention, the mobile node determines the possibility for device-to-device communication to the remote party without attempting to establish the communication via the core network, that is, via at least one router or other node in the core network.

In one embodiment of the invention, the mobile node determines the possibility for device-to-device communication using a separate query to a network node that maps the remote party identifier to an identifier of the remote mobile node. The base station may determine that the remote mobile node identified is within the same cell as the mobile node and in response issue to the mobile node an assignment of a radio resource for radio transmission to a remote mobile node directly.

At step 504 the base station determines that the remote party identifier is associated with a mobile node served by the base station.

At step 506 the base station receives a radio resource reservation from the mobile node.

At step 508 the base station transmits to the mobile node an assignment of a radio resource for device-to-device radio transmission to a remote mobile node.

At step 510 the base station may receive an indication of a non-availability of a band comprising the radio resource.

At step 512 the base station transmits a request to the mobile node to stop using the radio resource.

The embodiments of the invention described hereinbefore in association with FIGS. 4 and 5 may be used in any combination with each other. Several of the embodiments may be combined together to form a further embodiment of the invention.

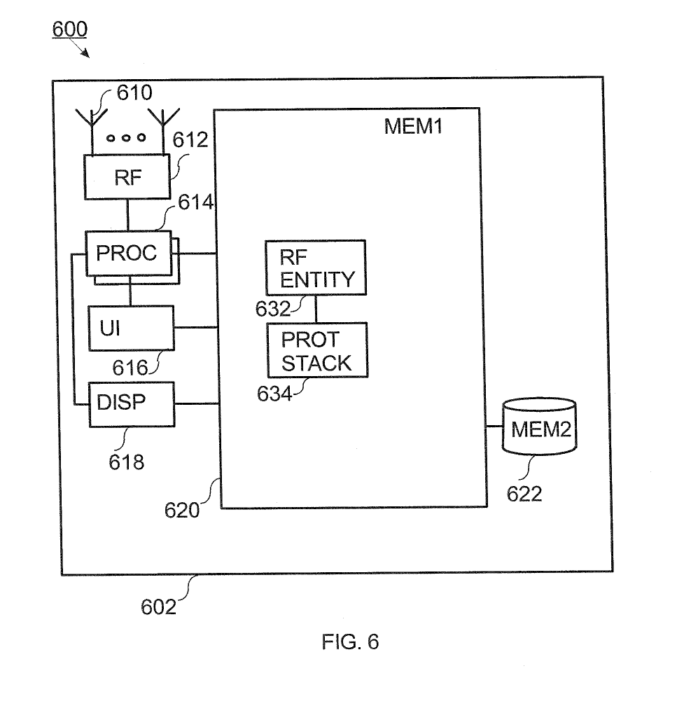

FIG. 6 is a block diagram illustrating an apparatus in one embodiment of the invention. In FIG. 6 there is an apparatus 600, which is, for example, a mobile node, user equipment, a handset, a cellular phone, a mobile terminal, an Application Specific Integrated Circuit (ASIC), a chip or a chipset. Apparatus 600 may correspond to a mobile node illustrated in FIGS. 1, 2, 3A, 3B and 4. The internal functions of mobile node 600 are illustrated with a box 602. Mobile node 600 may comprise at least one antenna 610. There may be multiple input and output antennas. In association with mobile node there is Radio Frequency (RF) circuit 612. RF circuit 612 may be also any circuit or may be referred to as circuit 612. RF circuit 612 is communicatively connected to at least one processor 614. Connected to processor 614 there may be a first memory 620, which is, for example, a Random Access Memory (RAM). There may also be a second memory 622, which may be a non-volatile memory, for example, an optical or magnetic disk. There may also be a User Interface (UI) 616 and a display 618. In memory 620 there may be stored software relating to functional entities 632 and 634. An RF entity 632 communicates with RF circuit 612 to perform radio resource allocation, de-allocation, signaling plane and user plane data transmission and reception. RF entity 632 receives an indication of radio resources to be used and request to perform device-to-device transmission testing from a base station via a protocol stack 634. Protocol stack entity 634 comprises control plane protocol functions related to the interface towards an eNB or any base station. RF circuit 612 may comprise the transmitter for SC-FDMA and the receiver and transmitter for OFDMA. RF circuit 612 may also comprise a receiver for SC-FDMA.

When the at least one processor 614 executes functional entities associated with the invention, memory 620 comprises entities such as, any of the functional entities 632 and 634. The functional entities within apparatus 600 illustrated in FIG. 6 may be implemented in a variety of ways. They may be implemented as processes executed under the native operating system of the network node. The entities may be implemented as separate processes or threads or so that a number of different entities are implemented by means of one process or thread. A process or a thread may be the instance of a program block comprising a number of routines, that is, for example, procedures and functions. The functional entities may be implemented as separate computer programs or as a single computer program comprising several routines or functions implementing the entities. The program blocks are stored on at least one computer readable medium such as, for example, a memory circuit, memory card, magnetic or optical disk. Some functional entities may be implemented as program modules linked to another functional entity. The functional entities in FIG. 4 may also be stored in separate memories and executed by separate processors, which communicate, for example, via a message bus or an internal network within the network node. An example of such a message bus is the Peripheral Component Interconnect (PCI) bus.

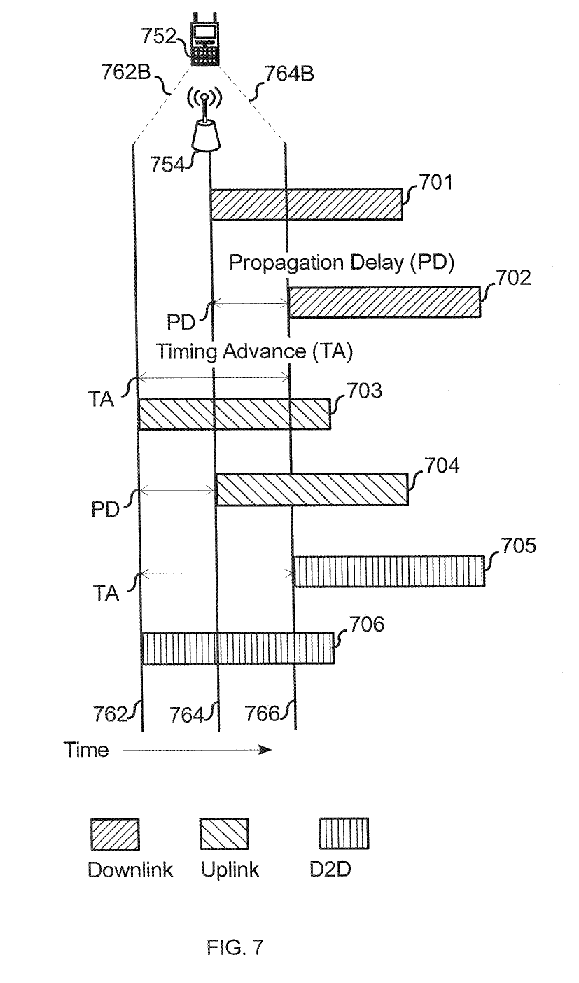

FIG. 7 illustrates a timing of device-to-device communication in one embodiment of the invention.

In FIG. 7 there is illustrated a base station 754 and a mobile node 752. The transmission time moment from mobile node 752 during uplink time is illustrated with line 762. The transmission time moment of base station 754 is illustrated with line 764. The reception time moment at the base station 754 is also illustrated with line 764. The transmission time moment from mobile node 752 during downlink time is illustrated with line 766. The fact that the time moments illustrated with lines 762 and 766 are associated with particularly mobile node 752 is illustrated with lines 762B and 764B, respectively. The remote node that mobile node 752 communicates with using device-to-device communication is not shown. Bar 701 illustrates a downlink signal or a part of a downlink signal, the transmission of which starts at time moment 764 from base station 754. Due to a signal Propagation Delay (PD) to mobile node 752, the downlink signal is observed to start at time moment 766 at mobile node 752, as illustrated with bar 702. The start of bar 701 may represent a symbol boundary, a slot boundary, a subframe boundary, a frame boundary or any point during downlink transmission. Further, due to signal propagation delay (PD) a transmission from mobile node 752 to base station 754 starts at moment 762, as illustrated with bar 703. In order to align uplink transmission from mobile node 752 with a particular time moment in downlink transmission from base station 754, as observed by a receiving mobile node at approximately the same distance from base station 754, for example, the remote node, mobile node 752 starts uplink transmission in advance at a Timing Advance (TA) before the particular time moment in the downlink transmission. The receiving of the uplink transmission from mobile node 752 starts at time moment 764 at base station 754, as illustrated with bar 704. The start of bar 704 may represent a symbol boundary, a slot boundary, a subframe boundary, a frame boundary or any point during downlink transmission.

Device-to-device transmission from mobile node 752 to the remote node starts at time moment 766, during a downlink time when a downlink signal may be received from base station 754 to mobile node 752 and the timing for device-to-device transmission is based on a potential downlink signal. This is illustrated with bar 705. The timing may be based on particular points in the downlink signal such as, for example, a symbol boundary, a slot boundary, a subframe boundary, a frame boundary or any point during a potential downlink transmission. The remote node observes the transmission from mobile node 752 to be time aligned with a potential downlink transmission from base station 754. Downlink transmission may be intermittent or absent at certain time intervals. By downlink time may be meant, for example, a downlink subframe such as, for example, subframe SF #9 illustrated in FIG. 3A or a downlink pilot time slot such as DwPTS illustrated in FIG. 3A during subframe SF #6.

Device-to-device transmission from mobile node 752 to the remote node starts at time moment 762, during an uplink time when an uplink signal is potentially transmitted from mobile node 752 to base station 754 and the timing is based on the potentially transmitted uplink signal. The timing may be based on particular points in the uplink signal such as, for example, a symbol boundary, a slot boundary, a subframe boundary, a frame boundary or any point during uplink transmission. This is illustrated with bar 706. By uplink time may be meant, for example, an uplink subframe such as, for example, subframe SF #8 illustrated in FIG. 3A or an uplink pilot time slot such as UpPTS illustrated in FIG. 3A during subframe SF #6. In FIG. 7 the propagation delay between mobile node 752 and the remote node is ignored.

The embodiments of the invention described hereinbefore in association with FIG. 7 presented may be used in any combination with each other. Several of the embodiments may be combined together to form a further embodiment of the invention.

The exemplary embodiments of the invention can be included within any suitable device, for example, including any suitable servers, workstations, PCs, laptop computers, PDAs, Internet appliances, handheld devices, cellular telephones, wireless devices, other devices, and the like, capable of performing the processes of the exemplary embodiments, and which can communicate via one or more interface mechanisms, including, for example, Internet access, telecommunications in any suitable form (for instance, voice, modem, and the like), wireless communications media, one or more wireless communications networks, cellular communications networks, 3G communications networks, 4G communications networks Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware art(s). For example, the functionality of one or more of the components of the exemplary embodiments can be implemented via one or more hardware devices, or one or more software entities such as modules.

The exemplary embodiments can store information relating to various processes described herein. This information can be stored in one or more memories, such as a hard disk, optical disk, magnetooptical disk, RAM, and the like. One or more databases can store the information regarding cyclic prefixes used and the delay spreads measured. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be implemented by the preparation of one or more application-specific integrated circuits or by interconnecting an appropriate network of conventional component circuits, as will be appreciated by those skilled in the electrical art(s).

As stated above, the components of the exemplary embodiments can include computer readable medium or memories according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Nonvolatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

The embodiments of the invention described hereinbefore in association with the figures presented may be used in any combination with each other. Several of the embodiments may be combined together to form a further embodiment of the invention.

It is obvious to a person skilled in the art that with the advancement of technology, the basic idea of the invention may be implemented in various ways. The invention and its embodiments are thus not limited to the examples described above; instead they may vary within the scope of the claims.

1. A method, comprising:
receiving at a mobile node at least one synchronization signal from a base station;
determining timing at the mobile node based on the at least one synchronization signal from the base station;
transmitting an uplink radio resource reservation request to the base station from the mobile node;
receiving from the base station an assignment of a radio resource dedicated for radio transmission to a remote node, the radio resource being within a band having a transmission power upper limit; and
transmitting a first data signal to the remote node on the radio resource based on the timing determined.

2. The method according to claim 1, the method further comprising:
transmitting a communication set-up request from the mobile node, the request comprising an identifier of a remote party, the identifier of the remote party being associated with the remote node.

3. The method according to claim 1, the method further comprising:
transmitting at least one test signal between the mobile node and the remote node to determine whether the mobile node and the remote node are within a range providing sufficient radio quality for communication between the mobile node and the remote node.

4. The method according to claim 3, the method further comprising:
receiving from the base station a request to execute the transmission of the at least one test signal; and reporting a quality of reception of the at least one test signal to the base station.

5. The method according to claim 1, the method further comprising:
switching to reception on the radio resource in the mobile node; and
receiving a second data signal from the remote node to the mobile node on the radio resource.

6. The method according to claim 1, the method further comprising:
transmitting the first data signal and the second data signal using a orthogonal frequency division multiple access transmitter.

7. The method according to claim 1, the method further comprising:
transmitting the first data signal and the second data signal using a single carrier frequency division multiple access transmitter.

8. The method according to claim 1, the method further comprising:
receiving from the base station a request to stop using the radio resource at the mobile node.

9. The method according to claim 8, the method further comprising:
receiving from the base station an assignment of an uplink radio resource for communication to the base station; and
continuing communication with the remote node using the uplink radio resource.

10. The method according to claim 1, the method further comprising:
transmitting the first data signal in a first slot of a subframe preceding a physical broadcast channel; and
switching to receiving the physical broadcast channel from the base station during a second slot of the subframe preceding a physical broadcast channel.

11. The method according to claim 1, wherein the mobile node comprises a Long-Term Evolution (LTE) User Equipment.

12. The method according to claim 1, wherein the transmitting of the first data signal during a special subframe is restricted to have a duration corresponding to the length of a downlink pilot time slot.

13. The method according to claim 1, wherein the remote node is a remote mobile node.

14. The method according to claim 1, wherein the radio resource dedicated for radio transmission to the remote node is within a television white space band which is adjacent to an occupied television channel.

15. A method, comprising:
transmitting at least one synchronization signal to a mobile node;
receiving a communication set-up request from the mobile node, the request comprising an identifier of a remote party, the identifier of the remote party being associated with a remote node;
determining that the remote party uses the remote node, the remote node being served by the base station;
receiving, at the base station, an uplink radio resource reservation request from the mobile node; and
transmitting from the base station an assignment of a radio resource dedicated for radio transmission to the remote node, the radio resource being within a band having a transmission power upper limit.

16. The method according to claim 15, wherein the step of determining that the remote party uses the remote node further comprising:
transmitting the communication set-up request to a core network node; and
receiving a indication of the communication set-up request to the base station from the core network node, the indication comprising an identifier of the remote node.

17. The method according to claim 15, the method further comprising:
determining that the remote node is within a transmission range of the mobile node.

18. The method according to claim 17, wherein the step of determining that the remote node is within the transmission range of the mobile node further comprises:
transmitting from the base station a request to execute the transmission of at least one test signal between the mobile node and the remote node; and receiving a report of a quality of reception of the at least one test signal to the base station.

19. The method according to claim 17, wherein the determination that the remote node is within a transmission range of the mobile node uses at least one of a satellite positioning system, a geographic positioning system of a mobile communication system, and a determination of a sector of the mobile node and the remote node.

20. The method according to claim 15, wherein the remote node is a remote mobile node.

21. The method according to claim 15, wherein the radio resource dedicated for radio transmission to the remote node is within a television white space band which is adjacent to an occupied television channel.

22. An apparatus, comprising:
at least one radio frequency circuit configured to receive at least one synchronization signal from a base station, to determine timing based on the at least one synchronization signal from the base station, and to transmit a first data signal to a remote node on a radio resource based on the timing determined; and
at least one processor configured to transmit an uplink radio resource reservation request to the base station, to receive from the base station an assignment of the radio resource dedicated for radio transmission to the remote node, the radio resource being within a band having a transmission power upper limit.

23. A base station, comprising:
at least one radio frequency circuit configured to
transmit at least one synchronization signal to a mobile node; and
at least one processor configured to receive a communication set-up request from the mobile node, the request comprising an identifier of a remote party, the identifier of the remote party being associated with a remote node, to determine that the remote party uses the remote node, the remote node being served by the base station, to receive an uplink radio resource reservation request from the mobile node, and to transmit an assignment of a radio resource dedicated for radio transmission to the remote node, the radio resource being within a band having a transmission power upper limit.

24. A computer program comprising code adapted to cause the following when executed on a data-processing system:
receiving at a mobile node at least one synchronization signal from a base station;
determining timing at the mobile node based on the at least one synchronization signal from the base station;
transmitting an uplink radio resource reservation request to the base station from the mobile node;
receiving from the base station an assignment of a radio resource dedicated for radio transmission to a remote node, the radio resource being within a band having a transmission power upper limit; and
transmitting a first data signal to the remote node on the radio resource based on the timing determined.

25. The computer program according to claim 24, wherein said computer program is stored on a computer readable medium.

26. A computer program comprising code adapted to cause the following when executed on a data-processing system:
transmitting at least one synchronization signal to a mobile node;
receiving a communication set-up request from the mobile node, the request comprising an identifier of a remote party, the identifier of the remote party being associated with a remote node;
determining that the remote party uses the remote node, the remote node being served by the base station;
receiving, at the base station, an uplink radio resource reservation request from the mobile node; and
transmitting from the base station an assignment of a radio resource dedicated for radio transmission to the remote node, the radio resource being within a band having a transmission power upper limit.

27. The computer program according to claim 26, wherein said computer program is stored on a computer readable medium.
